(19) United States
(12) Patent Application Publication
(10) Pub. No.: US 2006/0231978 A1
(43) Pub. Date: Oct. 19, 2006

(54) Method and apparatus for compression moulding preforms for synthetic resin containers

(75) Inventors: Dario Beltrandi, Imola (IT); Alessandro Balboni, Granarolo Dell'Emilia (IT); Fiorenzo Parrinello, Medicina (IT); Zeno Zuffa, Borgo Tossignano (IT)

Correspondence Address: BROWDY AND NEIMARK, P.L.L.C.;624 NINTH STREET, NW, SUITE 300, WASHINGTON, DC, 20001-5303, US

(73) Assignee: SACMI COOPERATIVA MECCANICI IMOLA SOCIETA COOPERAT A, BOLOGNA (IT)

(21) Appl. No.: 10/556,386

(22) PCT Filed: May 17, 2004
(86) PCT No.: PCT/EP04/05276

§ 371 Date: Nov. 10, 2005

(30) Foreign Application Priority Data
May 20, 2003 (IT) RE2003A000050

(51) Int. Cl. B29C 43/02

(52) U.S. Cl. 264/319; 425/394

(57) ABSTRACT

The apparatus serves for compression moulding performs (9) for synthetic resin containers by inserting under pressure a mould punch (15) into a die cavity (20a) loaded with a charge (8), the preforms (9) comprising an upper neck (91) provided with projections and a hollow body (92) lying below the neck (91). The apparatus comprises a plurality of first die components (21), each arranged to form the outer surface of the hollow body (92) of the perform (9), and being operated by inserting said punch (15) underpressure into each of them, to compression mould the perform (9). An equal plurality of second die components (22) are provided, each arranged to form the outer surface of the neck (91), each being associated with and secured to the first die component (21), said second component (22) being divided into at least two sectors (23) to be drawn apart to extract the preform (9). According to the method of the invention, during the step of feeding the charge into the die cavity the second die component is associated with the first die component, said second component being divided into at least two sectors able to be drawn apart to extract the preform.

### TECHNICAL FIELD

The present invention relates to the compression moulding of performs (semi-finished pieces) intended for the subsequent formation (typically by blow-moulding) of synthetic resin containers, the perform being moulded by inserting a punch (male mould element) under pressure into a hollow die (female mould part) loaded with a charge of solid, pasty or liquid material, in particular a thermoplastic resin, the preform comprising an upper neck provided with projections and a hollow body lying below the neck.

More precisely, the invention relates to a method and the relative apparatus having a plurality of dies for compression moulding preforms, each die comprising a first component for forming the outer surface of the hollow body, said first die components being driven and operated by inserting the mould punch under pressure, into the interior of each of them, to compression mould the preform.

### PRIOR ART

The hollow body of the preform has an outer shape which is smooth and axial, in particular free from undercuts, and can hence be extracted by axially moving the relative first die component, which can therefore be advantageously made with a monolithic body, in particular a body the parts of which are not radially drawn apart for the extraction.

In contrast, the neck of the preform possesses projections which form undercuts preventing its extraction from the die by simple movement in an axial direction. This means that the second die component, that provided to form the neck, must be made in several separable sectors which must be manipulated, with consequent mechanical complications which lead to applying that entire mould part concerned with the neck (both the punch and the neck die component) on that apparatus part which inserts the punches into the dies.

Other technical complications arise in the case in which the material charge is not completely contained in the cavity of that die part concerned with the hollow body of the preform, whether inserted into the cavity in substantially liquid form or in the form of a more or less solid elongate cylinder.

In this second case, this cylinder necessarily presents a diameter less than the minimum cavity of the die to enable it to be quickly inserted therein; as a result, particularly for containers having a capacity less than about 0.3 litres, it happens that the (axial) length of the material charge is greater than the cavity of the first die component and that hence the material charge, inserted into said cavity, projects externally upwards.

This results in problems and/or complications in the fitting-together of the die components in the step following insertion of the material charge into the first die component (but prior to the insertion of the punch into the die cavity), caused by the fact that the material charge can project from the cavity not only upwards but also radially (especially if pasty and therefore is unable to fold back radially from outside the cavity), it hence being impossible to lower the second die component onto the first in an axial direction, because it would intercept the top of the material charge.

Similar obstacles and complications occur in the other case, in which the material charge is substantially liquid and the capacity of that part of the die concerned with the hollow body is insufficient to contain it.

### DISCLOSURE OF THE INVENTION

An object of the invention is to generally solve said technical problems.

This and further objects are attained by the invention as characterised in the claims.

The method of the invention relates to a mould comprising a first die component arranged to form the outer surface of the hollow body, and a second die component arranged to form the outer surface of the neck, and is characterised in that during the step of inserting the charge into the die cavity the second die component is associated with the first die component, said second component being divided into at least two sectors able to be drawn apart to extract the preform.

According to a first embodiment of the method, the second die component remains constantly associated with the first die component during the entire moulding cycle.

According to another embodiment of the method, the second die component is withdrawn from the first die component during the step of extracting the preform from the die.

The apparatus according to the invention comprises a plurality of die units each comprising a first die component for forming the outer surface of the preform hollow body, and a second component for forming the outer surface of the neck and associated with and secured, at least during the step of inserting the charge (8) into the die cavity, to the first die component, which second component is divided into at least two sectors to be drawn apart to extract the preform.

According to another aspect of the invention, the apparatus comprises, for compression moulding the preforms, a plurality of mutually independent shuttles to be driven and operated by inserting the punch into each of them under pressure to compression mould the preform; each of said shuttles comprises said first die component and said second die component (22), this being associated with and secured to the shuttle, at least during the step of inserting the charge (8) into the die cavity (20a), and is movable together with it, said second component being divided into at least two sectors to be drawn apart to extract the preform.

### BRIEF DESCRIPTION OF THE DRAWINGS

The invention is described in detail hereinafter with the aid of the accompanying figures which illustrate one embodiment thereof by way of non-limiting example.

FIG. 1 is a perspective view of a first embodiment of the die unit, shown partly sectioned.

FIG. 2 is a vertical side elevation of FIG. 1.

FIG. 3 is a section on the plane III-III of FIG. 2.

FIG. 4 is a schematic plan view of a turntable apparatus for moulding preforms by a plurality of shuttles.

FIGS. 5A-5E show a succession of steps during the moulding of the preform according to the first embodiment of the method of the invention the invention.

FIGS. 6A and 6B show further steps in which the punch and then the preform are extracted from the die according to the first embodiment of the method of the invention.

FIG. 7 shows an example of a preform obtained by the invention.

FIG. 8 is a section, similar to FIG. 3, of a second embodiment of the die unit.

FIG. 9 is a section on the axial plane IX-IX of FIG. 8.

FIG. 10 is a section on the plane X-X of FIG. 8.

FIGS. 11A, 11B and 11C show steps subsequent to the compression, in which the punch and then the preform are extracted from the die.

FIGS. 12A, 12B, 12C, 12D, 12E, 12F, 12G and 12H show a succession of steps during the moulding of the preform and during the subsequent extraction of the preform, according to the second embodiment of the method of the invention.

### BEST MODE FOR CARRYING OUT THE INVENTION

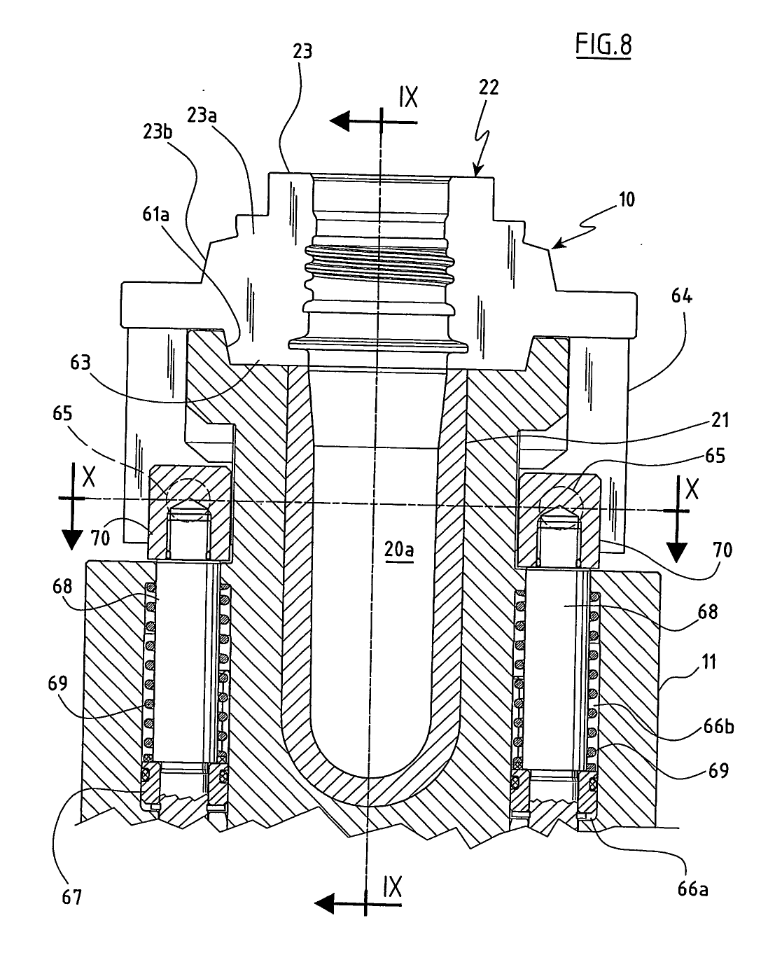

An example of a preform to be obtained according to the invention is shown in FIG. 7. This preform, indicated by 9, is intended to form (typically by blow-moulding) bottles of thermoplastic PET resin and comprises a neck 91, having the final shape required for the bottle, and a hollow body 92 which during bottle moulding forms its container part.

Generally, the neck 91 is provided with projections defining for example a thread 93 projecting radially outwards to receive a usual screw cap.

The preform 9 is obtained by a compression moulding process in which a punch 15 (mould male element) is inserted under pressure into a hollow die (mould female part) loaded with a charge 8 of material (solid, paste or liquid), in particular a thermoplastic resin. The die cavity 20a shapes the outer surface of the preform while the outer surface of the punch 15 shapes the inner surface thereof.

The apparatus of the invention operates by means of a plurality of die units 10 which, in a preferred embodiment, are constrained, while secured rigidly together, to move along an operative path in a horizontal plane (for example by being fixed to the same rotating platform of a turntable) while being moved vertically independently of each other when required, each of said die units 10 comprising a main body 11 containing a first die component 21 and other members.

Alternatively, said die units 10 can be incorporated in shuttles movable independently of each other, each shuttle comprising a main body 11 containing the first die component 21 and the other members. These shuttles are mutually independent and are arranged to be driven and operated within the apparatus which, inter alia, inserts said mould punch under pressure into each of them to compression mould the preform.

Essentially, the die unit 10 of the invention comprises a main body 11 carrying and enclosing a first die component 21, the inner surface of which forms the outer surface of the hollow body 92 of the preform 9. The main body 11 can be separate from the first die component 21, in which case it acts only as a support therefore (as shown in the figures), or can be integral therewith.

(In the preferred embodiment, the bodies 11 are mutually rigid within the apparatus).

According to the invention, the die unit 10 comprises a second die component 22, which forms the outer surface of the neck and is permanently secured to the die unit 10, and is divided into at least two complementary sectors 23 (in the embodiment shown in the figures, these sectors are two in number), able to be drawn apart to enable the preform to be extracted; when in their closed condition, these sectors 23 intimately adhere to each other via two respective matching faces 23a (these faces are flat and perpendicular to the direction in which the two sectors 23 move towards and away from each other) and also mate with the upper end of the first component 21 to form the die cavity 20a which shapes the outer surface of the preform.

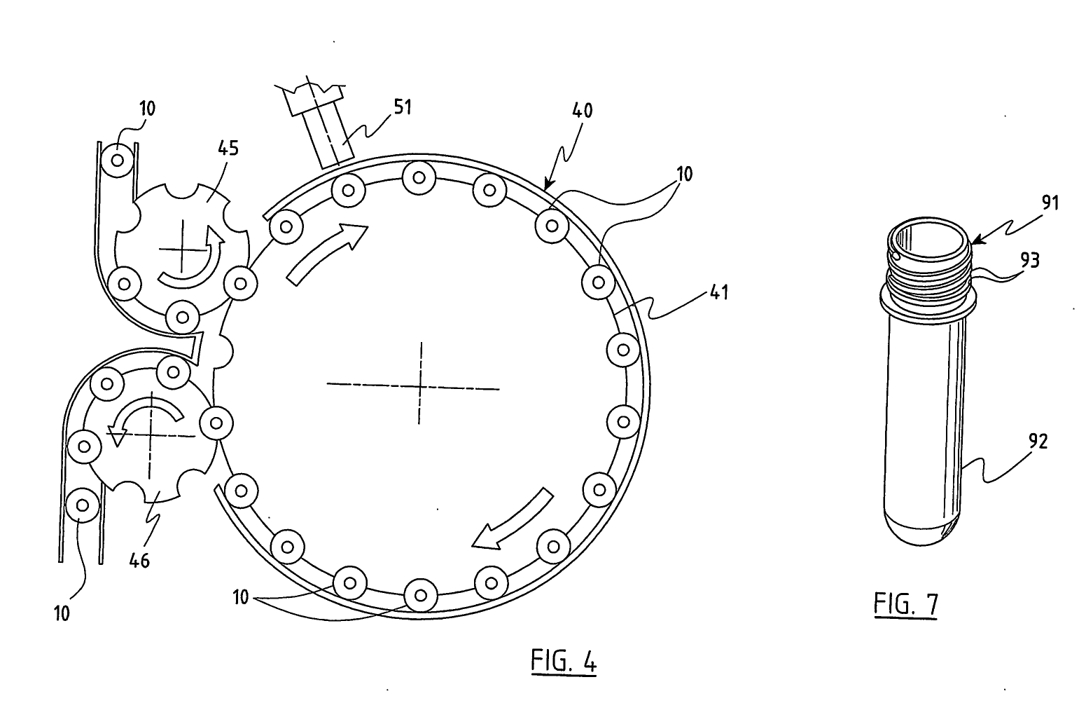

According to the embodiment shown in FIG. 4, the die units consist of a plurality of shuttles 10, identical and mutually independent, which are driven and operated by a turntable apparatus 40 to compression mould the preforms.

In FIG. 4 the apparatus 40 is shown very schematically as its configuration is not critical; it can also be of a different type, for example it can be rectilinear. What is relevant is that after a material charge 8 has been placed in the cavity 20a of the die positioned in each shuttle 10, the apparatus operates by inserting a punch 15 under pressure into each cavity 20a to compression mould the preform.

The shuttles 10 are initially introduced to the apparatus 40 by a usual introduction star member 45 which inserts them into a feed turntable 41 pertaining to the apparatus 40, to rotate the shuttles 10 through a path slightly less than 360°.

(In the preferred embodiment, the bodies 11 are rigid with the turntable 41 and therefore rotate constantly with it, without abandoning it).

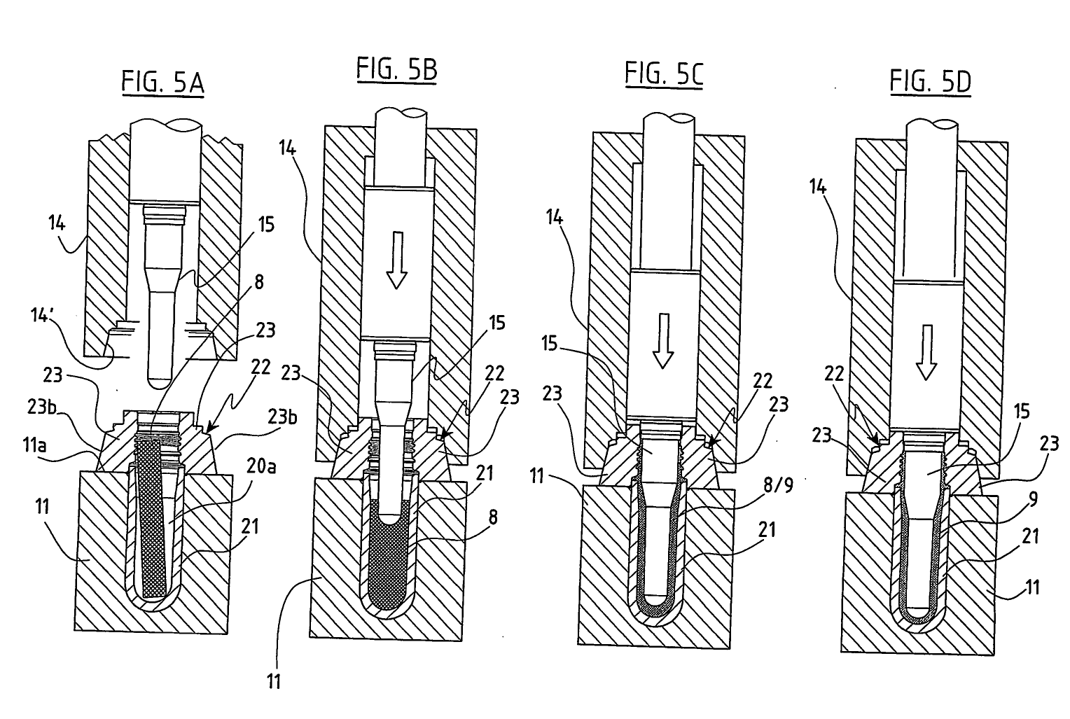

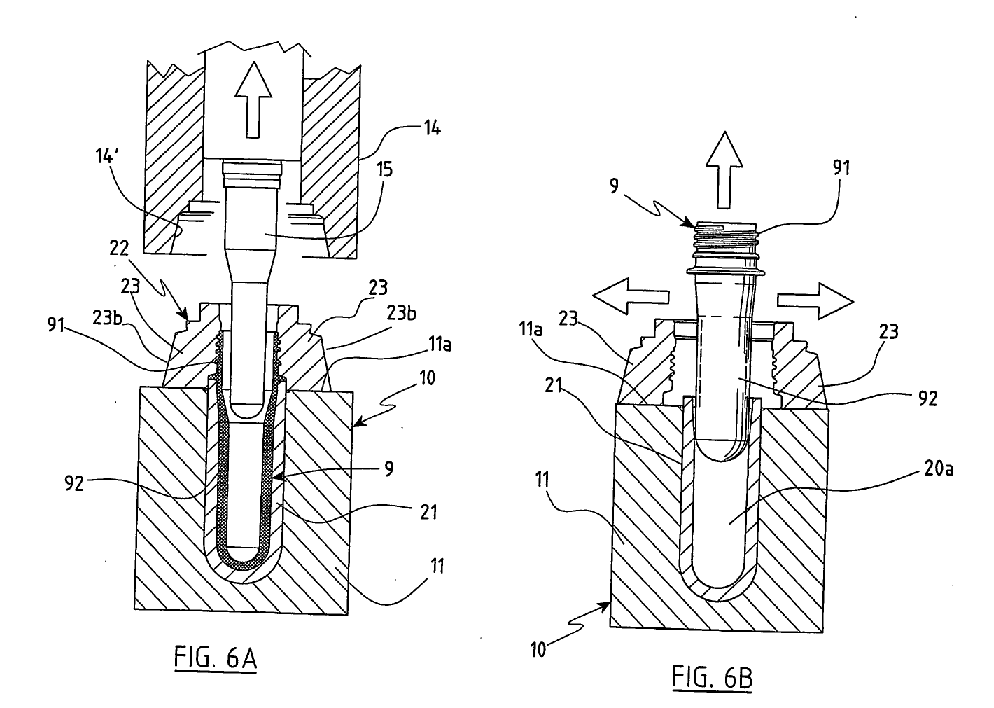

During the initial part of the path of the turntable 41, a respective charge 8 (solid, paste or liquid) is inserted into the cavity 20a of the shuttle 10 by a suitable dispenser device 51 (of known type). The apparatus 40 then inserts a respective punch 15 into each shuttle 10 while this advances together with the turntable 41. The punches 15 are not shown in FIG. 4, but only in FIGS. 5 and 6; the means for driving the punches 15 are not shown as they are of indeterminate type.

During the final part of the path, the shuttles 10 leave the turntable 41 via an extraction star member 46.

FIGS. 5A to 5D show a succession of operative steps relative to the insertion of the punch 15 with consequent compression moulding of the preform; said steps can be implemented either by moving the punch downwards (as shown in the figures) or alternatively by moving the shuttles 10 upwards.

Initially, the punch 15 approaches a shuttle 10 by descending vertically aligned with the axis A of the cavity 20a of the die, which is formed from the two components 21 and 22 in which the sectors 23 forming the component 22 are in the closed position (see FIG. 5A); a charge 8 is fed into the cavity 20a, which charge even if it projects upwards from the cavity of the first component 21 (in the case of a charge of substantially solid shown in FIG. 5A) would still be completely contained within the cavity material as which is also defined by the second component 22.

This aspect is very important not only if the charge is substantially solid, but also if it is substantially liquid and has a volume greater than the volume of the cavity of the first component 21, as the charge has to be fed into a cavity (the cavity 20a) having a capacity such as to contain it completely.

During the nest step (FIGS. 5B, 5C and 5D), the punch 15 penetrates into the cavity 20a and the charge 8 is compressed and deformed, and obliged to assume the shape defined in the interior of the cavity, until it assumes the final shape required for the preform 9 (FIG. 5D).

During a subsequent step in the moulding process (which may be relatively soon or long after the step of FIG. 5D), the punch 15 is extracted from the preform 9 while its neck 91 remains clamped between the sectors 23 of the second component 22, which are maintained in their closed configuration (see FIG. 6A).

During a further subsequent step, the sectors 23 are drawn apart and away from the preform 9, allowing this to be extracted in an axial direction from the cavity 20a (see FIG. 6B).

Alternatively the sector 23 can firstly be drawn apart to release the preform 9, which is extracted from the cavity 20a together with the punch 15, the said preform then being detached from the punch 15.

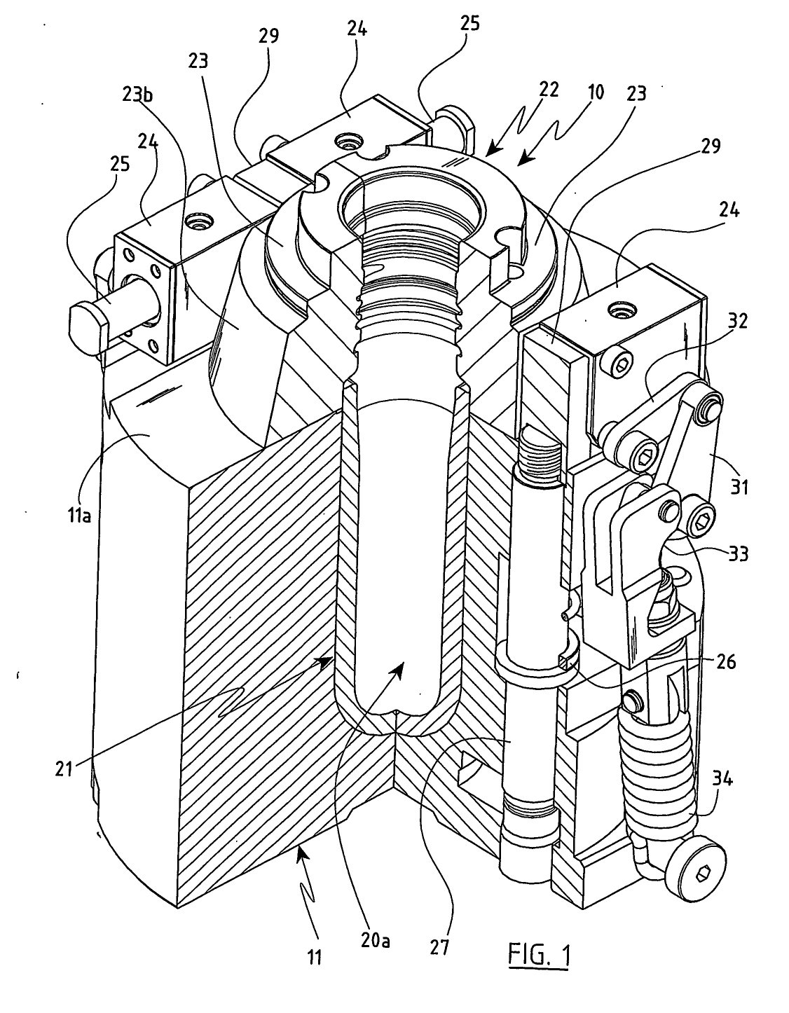

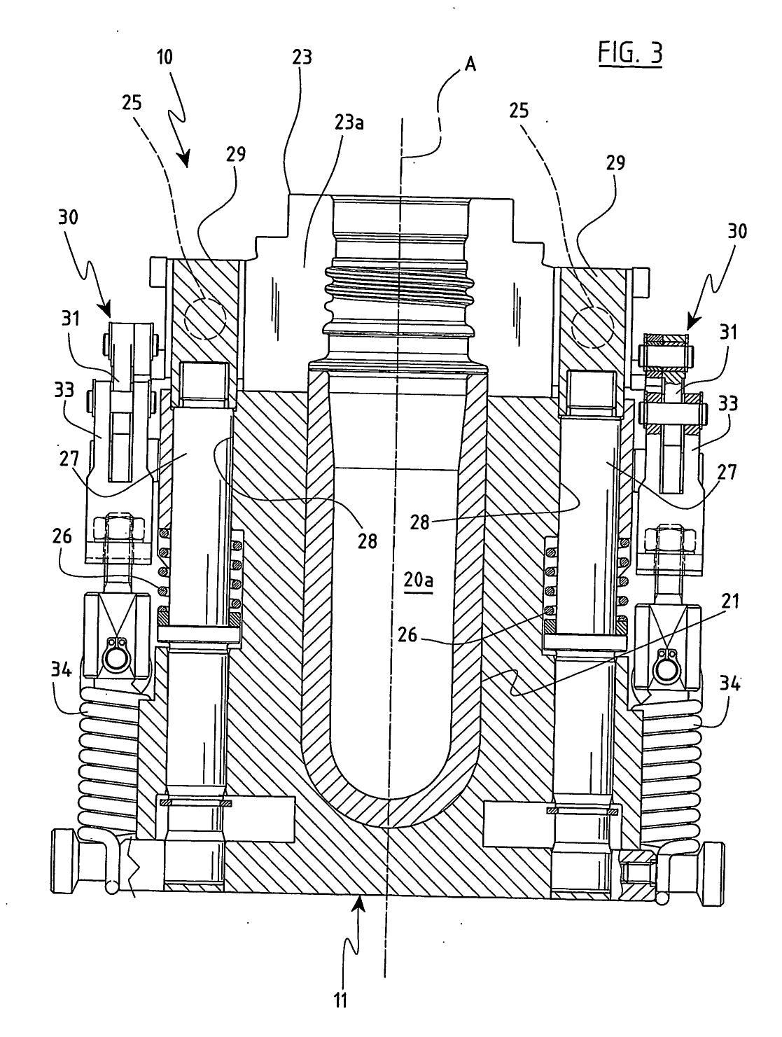

In the embodiment shown in FIGS. 1-3, the sectors 23 of the second die component 22 are placed, in their normally closed position, on the upper end of the main body 11 of the die unit (shuttle) and associated with the upper end of the first component 21 as a continuation of it, and are movable in a direction radial to the axis A of the cavity 20a. The main body 11 of the die 10 also comprises a horizontal upper surface 11a located in proximity to the upper end of the first die component 21, and on which the sectors 23 of the second component 22 adheringly bear, to be slidably movable on it.

Each sector 23 is joined to a pair of sliders 24 in the form of parallelepiped blocks fixed to two opposing sides of the sector and constrained to slide along respective horizontal parallel guides in the form of rods passing through the blocks, to determine the direction of mutual approach and withdrawal of the two sectors 23.

To maintain the respective sectors 23 in adhering contact with the upper surface 11a of the main body 11, the pairs of guides 25 are constantly pulled in an axial direction downwards by a pair of vertical ties 27. In detail, the ties 27 are slidably inserted into vertical channels 28 provided in the main body 11 and have their upper ends joined to respective blocks 29, to each of which the ends of the two guides 25 are rigidly butt-joined; the ties 27 are pulled constantly downwards by precompressed springs 26.

Two pairs of elastic means 30 are applied to two opposing sides of the body 11 of each die unit 10 in the angular position in which the ties 27 lie, to elastically urge the sectors 23 into their closed position. Each elastic means 30 comprises a lever 31 having a hinge pin 31a of horizontal axis fixed to the main body 11, with one end connected by a connecting rod 32 to a slider 24 and its other end connected by a tie 32 to a pre-stretched spring 34. A pair of said means 30 is applied to each slider 24, to urge the sectors 23 towards the axis A. The purpose of the means 30 is to maintain the two sectors 23 urged against each other while feeding the charge 8 into the die cavity 20a.

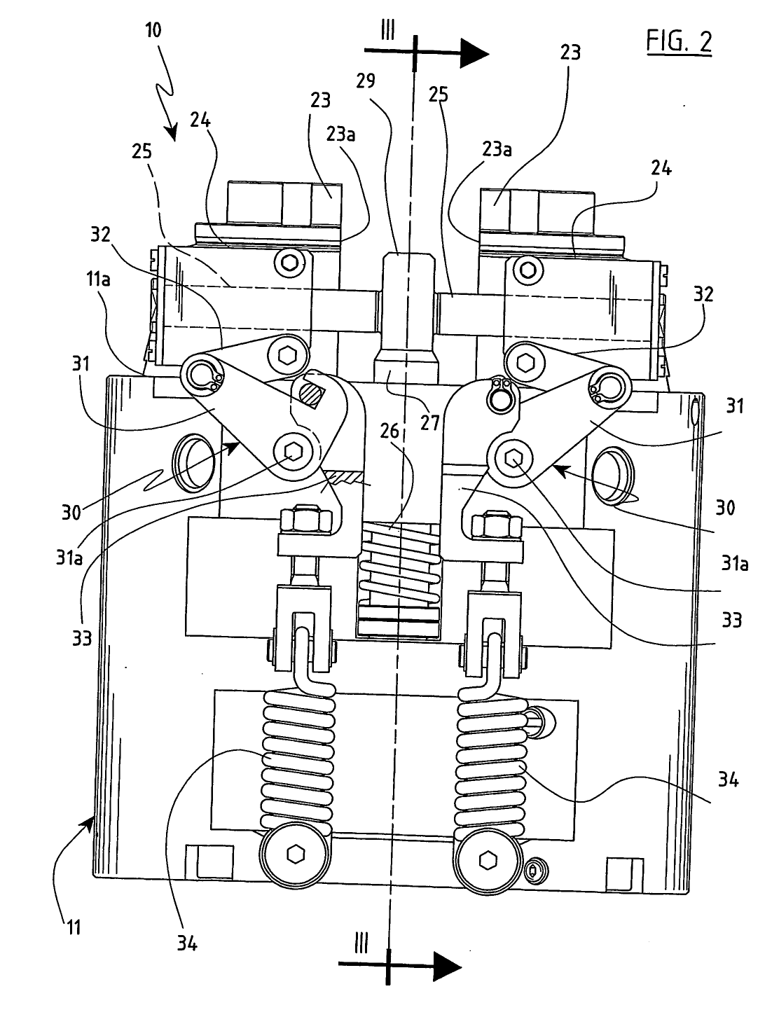

In FIG. 2 the two sectors 23 are shown in their open position.

During the step of compressing the charge 8 within the cavity 20a, the sectors 23 are locked in the closed position by means of known type comprising an upper body 14 associated with the punch 15 and movable vertically thereto, possessing a frusto-conical cavity 14′ surmounted by a cylindrical cavity, which matches the frusto-conical outer lateral surface 23b of the sectors 23 also surmounted by a cylindrical surface complementary to said cylindrical cavity (FIGS. from 5A to 5D), or by other means able to prevent the sectors being drawn apart due to the pressure produced within the cavity 20a.

The step of extracting the punch 15 from the preform 9 (shown in FIG. 6A) can take place, as stated above, while its neck 91 remains clamped between the sectors 23 of the second component 22. During this step, the punch 15 is firstly withdrawn axially, through a short distance, from the die and from the upper body 14 while this latter is kept thrust in order to adhere against the outer surface of the sectors 23; this serves to maintain the sectors 23 strongly clamped together to overcome the strong radial forces which, produced by the separation of the preform from the punch, would tend to draw the sectors 23 apart.

Subsequently, during the further axial withdrawal of the punch 15 from the die, as shown in FIG. 6A, the upper body 14 is also withdrawn from the die.

During the preform extraction step, the two sectors 23 are gripped, by known means (indeterminate and not shown in the figures) which draws them apart by overcoming the thrust of the spring 34.

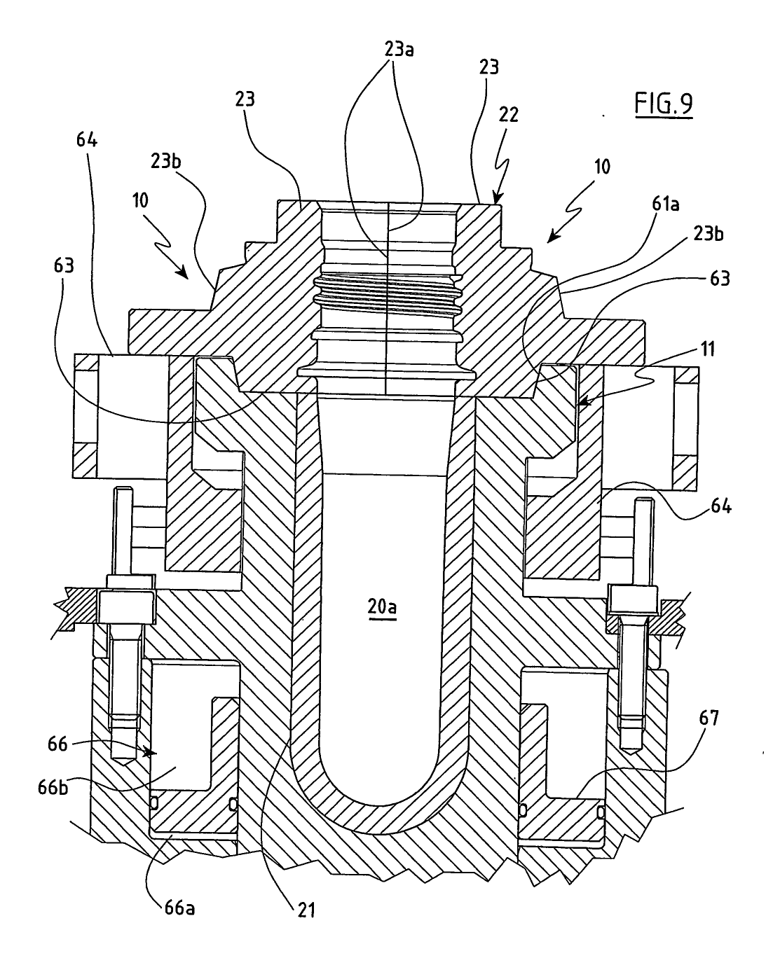

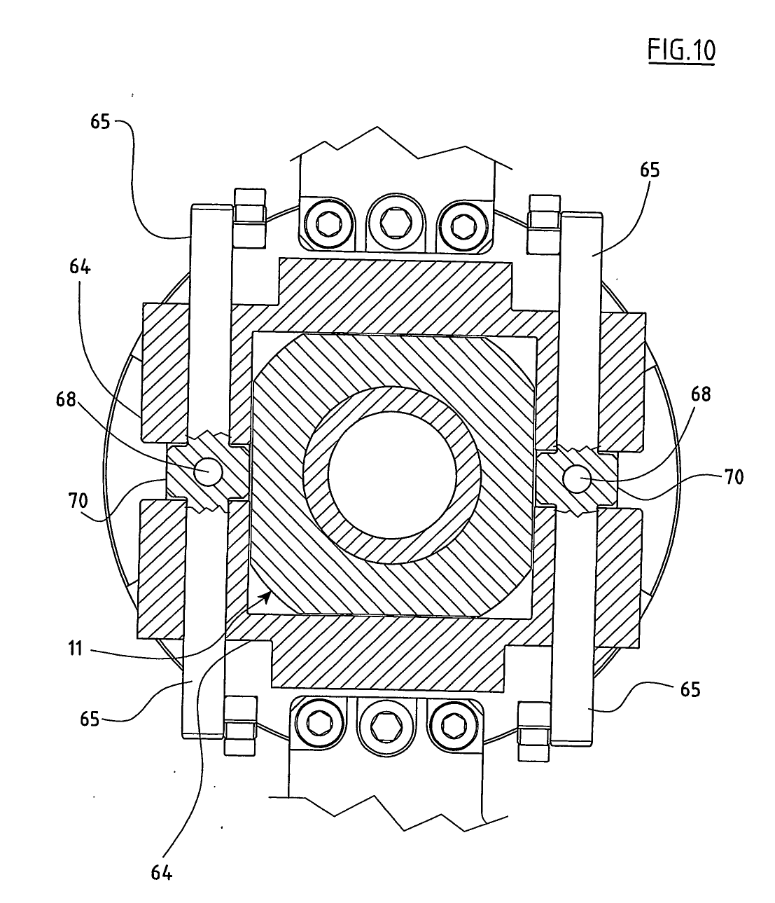

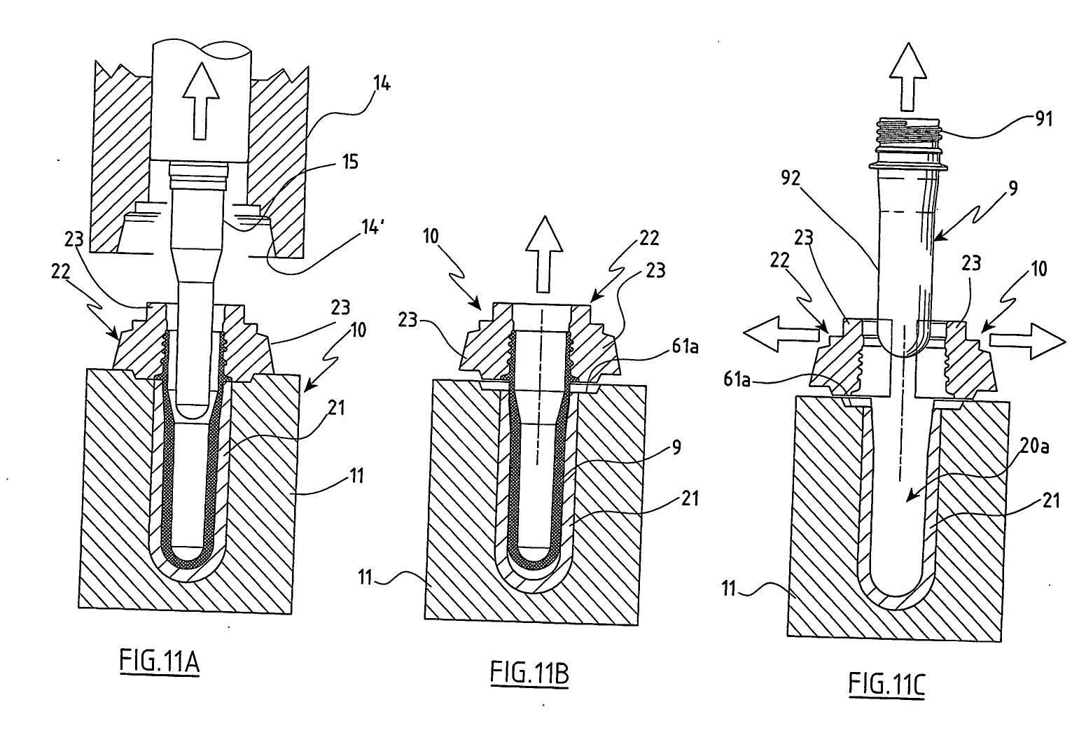

In the embodiment shown in FIGS. 8-10 the sectors 23 of each second die component 22, like the first embodiment, are placed in their normally closed position on the upper end of the main body 11 of the die unit, associated with the upper end of the first component 21 as a continuation of it, and are movable in a direction radial to the axis A of the cavity 20a.

However, this version differs from the preceding in that said sectors 23 are also movable in a vertical direction relative to the first component 21. The main body 11 also defines at the upper end of the first die component 21 a concave upper surface 61a coaxial with the axis A and having its concavity, in particular of frusto-conical shape, facing upwards and converging downwards, to surround the upper end of the first component 21; at the same time the sectors 23 possess respective lower projections 63 the lateral surfaces of which mate with the concave upper surface 61a, and together form a geometrical figure substantially complementary to the concavity defined thereby so that, when the sectors 23 are in their closed position (with the matching faces 23a mutually adhering) said projections 63 are positioned to adheringly bear against the concave surface 61a; said projections 63 also mate with the upper end of the first component 21 to give rise, together therewith, to the die cavity 20a which shapes the outer surface of the preform.

Each pair of sectors 23 comprises means for pulling them downwards until they are in their closed position adhering on the concave surface 61a, and means to raise said sectors 23 in an axial direction.

In greater detail, each sector 23 is rigidly fixed to a bracket 64 positioned below it to surround the upper end part of the main body 11 of the die unit on three sides, said brackets 64 being constrained to slide along respective parallel horizontal guides 65 consisting of rods passing through the brackets, to determine the direction in which the two sectors 23 mutually approach and withdraw from each other horizontally. In the lower part of the main body 11, about the first component 21, there is provided a cylinder-piston comprising a closed annular cavity 66 having cylindrical lateral surfaces and containing an annular piston 67 which sealedly slides along the lateral walls of the cavity 66, within which two variable volume chambers 66a and 66b remain defined above and below the piston 67, of which at least the lower chamber is in communication with pressurized operative fluid feed means (not shown in the figures).

Inside the cavity 66 there are two vertical piston rods 68, positioned in a vertical plane passing through the axis A and coplanar with the matching faces 23a of the sectors 23 on one and the other side of the axis A, their upper ends emerging to the outside of the main body 11 where they are fixed to respective blocks 70, to each of which the ends of two guides 65 are butt-joined; said piston rods 68 are fixed to the piston 67 and are driven upwards by it as far as its upper end position, consequently vertically moving the guides 65 and with them the two brackets 64 and the sectors 23 joined to them.

The downward movement of said elements is instead produced by the action of two precompressed elastic springs 69 wound about the piston rods 68.

These springs 69 normally pull the piston rods 68 downwards so that the sectors 23 are also pulled downwards with the projections 63 adhering to the surface 61a, this action advantageously serving to urge the two sectors 23 against each other into their closed position during the step in which the charge 8 is fed into the die cavity 20a and to maintain the cavity formed by the two sectors 23 adjacent to the cavity of the first component 21.

In FIGS. 8-10 the two sectors 23 are shown in their closed position.

During the step of compressing the charge 8 within the cavity 20a, the sectors 23 are locked in their closed position by said upper body 14 (of known type) associated with the punch 15, the frusto-conical cavity 14′ of which mates with the frusto-conical outer lateral surface 23′ of the sectors 23, or by other means able to prevent the sectors drawing apart because of the pressure produced within the cavity 20a.

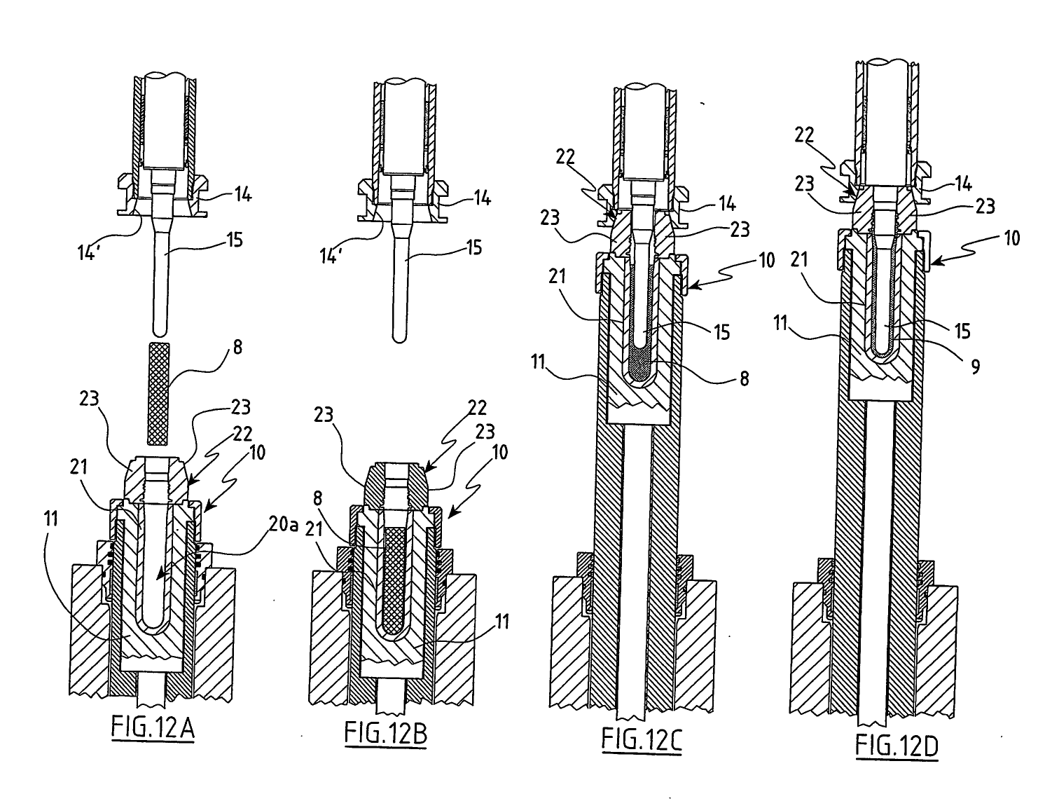

During a subsequent step (which may be relatively soon or long after the step of FIG. 5D), the punch 15 is extracted from the preform 9 while its neck 91 remains clamped between the sectors 23 of the second component 22, which are maintained in their closed configuration (see FIG. 11A); (the modalities of carrying out this step can be the same as aforedescribed with reference to FIG. 6A).

Pressurized fluid is then fed into the lower chamber 66a to overcome the action of the springs 69, so that the piston 67 is moved vertically upwards, and with it the two sectors 23 to release these latter from their bearing against the surface 61a (see FIG. 11 B); this also results in a first limited separation of the preform 9 from the die cavity 20a, as the preform neck 91 remains clamped between the sectors 23 of the second component 22, which are maintained in their joined-together configuration by said known means (indeterminate and not shown in the figures); the sectors 23 are then gripped by these means, which draw them apart by overcoming the action of the springs 34, to release the preform 9 so that it can be extracted from the cavity 20a in an axial direction (see FIG. 11C).

Alternatively the sectors 23 can firstly be drawn apart to release the preform 9, which is extracted from the cavity 20a together with the punch 15 on which it remains, the said preform then being detached from the punch 15.

FIGS. from 12A to 12H show a succession of steps during the formation of the preform and during the subsequent extraction of the perform, in the second embodiment of the method of the invention.

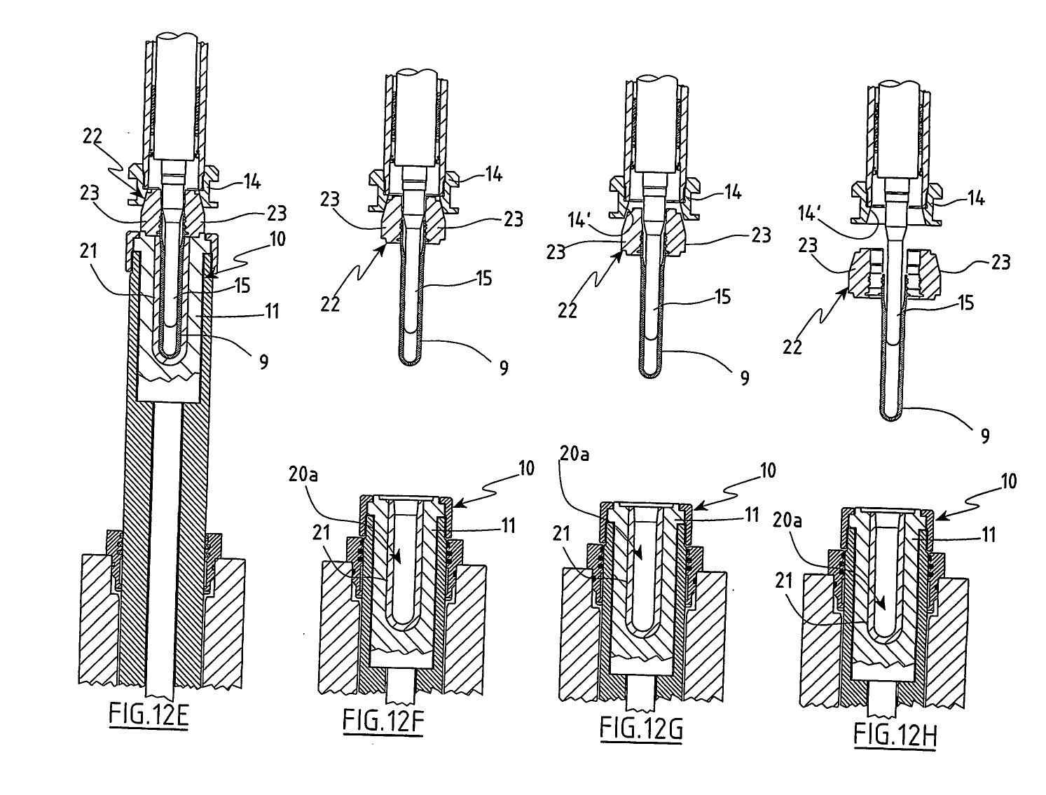

In this case, at the instant of inserting the charge 8 (FIG. 12A) into the die cavity 20a, the second die component 22 is associated with the first die component 21 and the sectors 23 which form the component are in their closed position.

The cavity 20a is fed with a charge 8 which, even if it were to project upwards above the cavity of the first component 21, would however be completely contained within the cavity also defined by the two sectors 23 in their closed position.

During the step of extracting the preform from the mould, the punch 15 is firstly (FIG. 12E) withdrawn axially through a short distance from the die and from the upper body 14 while this latter is kept thrust to adhere against the outer surface of the sectors 23, and these are kept thrust against the upper surface of the body 11 (as also occurs with the aforedescribed embodiments), in order to maintain the sectors 23 strongly clamped together. Specifically, the described relative movement is carried out while maintaining the punch axially at rest and moving both the entire die and the upper body 14 downwards.

Subsequently (FIG. 12F), the two sectors 23 are withdrawn axially from the first die component 21 together with the attached punch 15 (in particular the two sectors 23 and the upper body 14 remain at rest, together with the punch 15, and the first component 21 is moved downwards), so that the upper body 14 continues to adhere to the two sectors 23 to maintain them clamped together, and serve as a gripping means which acts on the neck of the preform 9, to extract this, with relative axial movement, from the cavity of the first component 21.

Then as shown in FIG. 12G, while still clamped together the sectors 23 are axially withdrawn from the upper body 14, and with them the preform 9 from the punch 15 (in particular, the sectors 23 are moved downwards).

Finally, the sectors 23 are drawn apart and withdrawn from the preform 9 (FIG. 12H) to free this for its removal.

In the embodiment illustrated in FIGS. from 12A to 12H, the punch 15 is axially fixed while the other mould parts are movable, in particular the die components 21 and 23 and the upper body 14.

In contrast, in the preceding FIGS. 5A-5D, 6A, 6B and 11A-11C, the axial position of the first die component 21 (and also of the sectors 23 in FIGS. 5A-5D, 6A, 6B) remains fixed whereas the other mould parts are movable.

What is important in the different embodiments is that the various mould 15 parts undergo axial movements relative to each other.

Numerous modifications of a practical and applicational nature can be made to the invention, but without leaving the scope of the inventive idea as claimed below.

1. A method for compression moulding preforms for synthetic resin containers by inserting under pressure a punch (15) into a mould die cavity (20a) loaded with a charge (8),
the preforms comprising an upper portion (91) provided with projections and a hollow body (92) lying below the upper portion (91),
the mould comprising a first die component (21), arranged to form the outer surface of the hollow body (92) of the preform (9),
said first die component (21) being operated by inserting said punch (15) under pressure into it, to compression mould the preform (9),
the mould also comprising a second die component (22) to form the outer surface of the upper portion (91),
characterised in that the second die component (22) is associated with the first die component (21) during the step of feeding the charge (8) into the die cavity (20a), said second component (22) being divided into at least two sectors (23) able to be drawn apart to extract the preform (9),
and the second die component (22) is withdrawn from the first die component (21) during the step of extracting the preform from the die.

2. An apparatus for compression moulding preforms for synthetic resin containers by inserting under pressure a mould punch (15) into a die cavity (20a) loaded with a charge (8), the preforms comprising an upper neck (91) provided with projections and a hollow body (92) lying below the neck (91), the apparatus comprising a plurality of first die components (21), each arranged to form the outer surface of the hollow body (92) of the preform (9), said first die components (21) being operated by inserting said punch (15) under pressure into each of them, to compression mould the preform (9), characterised by comprising:
an equal plurality of second die components (22), each arranged to form the outer surface of the neck (91), each being associated with and secured to the first die component (21) during the step of feeding the charge (8) into the die cavity (20a), said second component (22) being divided into at least two sectors (23), to be drawn apart to extract the preform (9), and means to withdraw the second die component (22) from the first die component (21) during the step of extracting the preform from the die.

3. An apparatus as claimed in claim 2, characterised in that said sectors (23) of the second die component (22) are associated, in their normally closed position, with the upper end of the first component (21) and are movable in a direction having a component radial to the axis (A) of the cavity (20a).

4. An apparatus as claimed in claim 3, characterised by comprising, for each first die component (21), a concave upper surface (61a) having its concavity facing upwards and converging downwards, to surround the upper end of the first component (21), the sectors (23) possessing respective lower projections (63) the lateral surfaces of which mate with the concave upper surface (61a), and together are complementary to the concavity defined by this surface (61a); said sectors (23) being movable both in a horizontal direction and in a vertical direction, said lower projections (63) adheringly bearing on the concave surface (61a) when the sectors are in their closed position.

5. An apparatus as claimed in claim 4, characterised by comprising, for each first die component (21), means arranged to pull the sectors (23) of the second die component downwards where, when in their closed position, they pullingly adhere to the concave surface (61a), and means to raise said sectors (23) in an axial direction.

6. An apparatus as claimed in claim 5, characterised in that said means for raising the sectors (23) of the second die component comprise a cylinder-piston formed from a closed annular cavity (66) provided in the lower part of the main body (11) about the first component (21) and having cylindrical lateral surfaces, and by an annular piston (67) which sealedly slides within the annular cavity (66) in which two variable volume chambers (66a and 66b) remain defined above and below the piston (67), of which at least the lower chamber is in communication with pressurized operative fluid feed means.

7. An apparatus as claimed in claim 2, characterised by comprising, for compression moulding the preforms, a plurality of mutually independent shuttles, to be driven and operated by inserting the punch (15) under pressure into each of them, to compression mould the preform (9), each shuttle (10) comprising said first die component (21) for forming the outer surface of the hollow body (92) of the preform (9),
and said second die component (22) for forming the outer surface of the neck and associated with and secured to the shuttle (10) during the step of feeding the charge (8) into the die cavity (20a) and movable together with it, said second component (22) being divided into at least two sectors (23) able to be drawn apart to extract the preform (9).

8-16. (canceled)

17. (canceled)

18. An apparatus as claimed in claim 4, characterised by comprising, for compression moulding the preforms, a plurality of mutually independent shuttles, to be driven and operated by inserting the punch (15) under pressure into each of them, to compression mould the preform (9),
each shuttle (10) comprising said first die component (21) for forming the outer surface of the hollow body (92) of the preform (9), and said second die component (22) for forming the outer surface of the neck and associated with and secured to the shuttle (10) during the step of feeding the charge (8) into the die cavity (20a) and movable together with it, said second component (22) being divided into at least two sectors (23) able to be drawn apart to extract the preform (9).

19. An apparatus as claimed in claim 5, characterised by comprising, for compression moulding the preforms, a plurality of mutually independent shuttles, to be driven and operated by inserting the punch (15) under pressure into each of them, to compression mould the preform (9),
each shuttle (10) comprising said first die component (21) for forming the outer surface of the hollow body (92) of the preform (9), and said second die component (22) for forming the outer surface of the neck and associated with and secured to the shuttle (10) during the step of feeding the charge (8) into the die cavity (20a) and movable together with it, said second component (22) being divided into at least two sectors (23) able to be drawn apart to extract the preform (9).

20. An apparatus as claimed in claim 6, characterised by comprising, for compression moulding the preforms, a plurality of mutually independent shuttles, to be driven and operated by inserting the punch (15) under pressure into each of them, to compression mould the preform (9),
each shuttle (10) comprising said first die component (21) for forming the outer surface of the hollow body (92) of the preform (9), and said second die component (22) for forming the outer surface of the neck and associated with and secured to the shuttle (10) during the step of feeding the charge (8) into the die cavity (20a) and movable together with it, said second component (22) being divided into at least two sectors (23) able to be drawn apart to extract the preform (9).

21. An apparatus for compression moulding preforms for synthetic resin containers by inserting under pressure a mould punch (15) into a die cavity (20a) loaded with a charge (8), the preforms comprising an upper neck (91) provided with projections and a hollow body (92) lying below the neck (91), characterised by comprising a plurality of mutually independent shuttles, movable independently of each other, each shuttle comprising: a first die components (21), arranged to form the outer surface of the hollow body (92) of the preform (9), a second die components (22), arranged to form the outer surface of the neck (91), associated with and secured to the first die component (21) during the step of feeding the charge (8) into the die cavity (20a), said second component (22) being divided into at least two sectors (23), to be drawn apart to extract the preform (9), said shuttles being able to be operated by inserting said punch (15) under pressure into each of them to compression mould the preform (9).

22. A shuttle as claimed in claim 21, characterised in that said sectors (23) of the second die component (22) are placed, in their normally closed position, on the upper end of the first component (21) and are movable in a direction having a component radial to the axis (A) of the cavity (20a).

23. A shuttle as claimed in claim 22, characterised in that each shuttle (10) comprises an upper surface (11a) at the upper end of the first die component (21), said sectors (23) of the second die component being positioned adheringly bearing on said upper surface (11a) and being slidably movable thereon.

24. A shuttle as claimed in claim 12, characterised in that each sector (23) is joined to a pair of sliders (24) constrained to slide along respective guides (25).

25. A shuttle as claimed in claim 24, characterised in that said pairs of guides (25) are pulled downwards in an axial direction to maintain the respective sectors (23) of the second die component (22) in adhering contact with the first component (21).

26. A shuttle as claimed in claim 24, characterised by comprising elastic means (30) for elastically urging the sectors (23) into their closed position.

27. A shuttle as claimed in claim 25, characterised in that each shuttle (10) comprises a concave upper surface (61a) having its concavity facing upwards and converging downwards, to surround the upper end of the first component (21), the sectors (23) of the second component (22) possessing respective lower projections (63) the lateral surfaces of which mate with the concave upper surface (61a), and together are complementary to the concavity defined by this surface (61a); said sectors (23) being movable both in a radial direction and in a vertical direction and said lower projections (63) being positioned adheringly bearing on the concave upper surface (61a) when said sectors are in their closed position.

28. A shuttle as claimed in claim 27, characterised in that comprises means to pull the sectors (23) of the second die component downwards where, when in their closed position, they pullingly adhere to the concave surface (61a), and means to raise said sectors (23) in an axial direction.

29. A shuttle as claimed in claim 28, characterised in that said means for raising the sectors (23) of the second die component comprise a cylinder-piston formed from a closed annular cavity (66) provided in the lower part of the main body (11) about the first component (21) and having cylindrical lateral surfaces, and by an annular piston (67) which sealedly slides within the annular cavity (66) in which two variable volume chambers (66a and 66b) remain defined above and below the piston (67), of which at least the lower chamber is in communication with pressurized operative fluid feed means.

30. An apparatus as claimed in claim 3, characterised by comprising, for compression moulding the preforms, a plurality of mutually independent shuttles, to be driven and operated by inserting the punch (15) under pressure into each of them, to compression mould the preform (9), each shuttle (10) comprising said first die component (21) for forming the outer surface of the hollow body (92) of the preform (9), and said second die component (22) for forming the outer surface of the neck and associated with and secured to the shuttle (10) during the step of feeding the charge (8) into the die cavity (20a) and movable together with it, said second component (22) being divided into at least two sectors (23) able to be drawn apart to extract the preform (9).
